(19) United States
(12) Patent Application Publication
(10) Pub. No.: US 2016/0073217 A1
(43) Pub. Date: Mar. 10, 2016

(54) METHODS AND SYSTEMS FOR SECURE ACTIVATION OF SOFTWARE LICENSES AND FEATURES

(71) Applicant: General Electric Company, Schenectady, NY (US)

(72) Inventor: Leif Peder Schmedling, Horten (NO)

(21) Appl. No.: 14/482,416

(22) Filed: Sep. 10, 2014

(51) Int. Cl. H04W 4/00; H04L 29/06; H04W 12/04; G06Q 50/18

(52) U.S. Cl. CPC H04W 4/008; G06Q 50/184; H04L 63/10; H04W 12/04

(57) ABSTRACT

Methods and systems for a near field communication (NFC) token is provided. The NFC token includes an antenna, and a memory device configured to store a license key. The license key is used by an NFC enabled medical system to activate a software feature of the NFC enabled medical system. The NFC token also includes a transmitter electrically coupled to the antenna and the memory device. The transmitter is configured to transmit information to the NFC enabled medical system when the transmitter is within an NFC activation field of the medical system. The transmit information includes the license key.

### BACKGROUND OF THE INVENTION

Embodiments described herein generally relate to near field communication, and more particularly to activate licenses for features of an ultrasound system based on transmissions from a near field communication device.

Ultrasound systems, when shipped from a manufacturer, are configured in a factory default configuration that includes standard or basic software features with respect to one or more ultrasound modes or ultrasound data analysis processes, such as, 2D scanning. Some of the ultrasound systems support advanced functions or features, such as, 3D scanning, 4D scanning, imaging analysis tools, or the like, which may be activated through software on the ultrasound system. Conventionally, the features are activated by users paying an activation fee to the manufacturer and manually entering one or more license keys into the ultrasound system.

The license keys, for example, may include a string of characters (e.g., numerals, letters, punctuation symbols, control codes, spaces), generated by the manufacturer using predefined algorithms (e.g., cryptographic security algorithms), that correspond to one or more advanced features paid for by the user. The license keys are conventionally long strings of characters, for example, 128 characters in length, to decrease the likelihood that forged license keys are generated. The license keys may be based on various proprietary or standard encoding schemes known in the art, such as, the American Standard Code for Information Interchange (ASCII). When one or more of the license key is entered and recognized, the software on the ultrasound system activates one or more of the corresponding advanced features.

Due to the size of the license keys, the entering process of the license key by the user can be prone to errors and cumbersome to the user. For example, if any character of the license key is incorrect, the user must re-perform the entering process. Further, the license keys may be re-used by users on ultrasound systems without paying the activation fee to the manufacturer. Additionally, if the ultrasound system is restored to a factory default configuration after the advanced features are activated, the user must manually reenter the license keys. For these and other reasons, an improved method and system is needed for activating software licenses and features.

### BRIEF DESCRIPTION OF THE INVENTION

In an embodiment, a near field communication (NFC) token is provided. The NFC token includes an antenna, and a memory device configured to store a license key. The license key is used by an NFC enabled medical system to activate a software feature of the NFC enabled medical system. The NFC token also includes a transmitter electrically coupled to the antenna and the memory device. The transmitter is configured to transmit information to the NFC enabled medical system when the transmitter is within an NFC activation field of the medical system. The transmit information includes the license key.

In another embodiment, a method is provided for secure activation of a software feature. The method includes providing a near Field communication (NFC) token configured to transmit a license key that corresponds to one or more software features of an NFC enabled medical system. The method also includes positioning the NFC token within an NFC activation range of the NFC enabled medical system, and transmitting the license key to the NFC enabled medical system.

In another embodiment, a method is provided for secure activation of a software feature. The method includes receiving a feature activation request from a user interface. The feature activation request corresponds to one or more software features of a near field communication (NFC) enabled medical system. The method includes generating an NFC activation field, and establishing truncation with an NFC token once the NFC token is positioned within the NFC activation field. The NFC token is configured to transmit a license key. The method includes transmitting identification information to the NFC token, and receiving the license key from the NFC token corresponding to the one or more software features.

### BRIEF DESCRIPTION OF THE DRAWINGS

FIG. 1 is an illustration of a near field communication token, in accordance with an embodiment.

FIG. 2 is an illustration of a simplified block diagram of a near field communication enabled medical system, in accordance with an embodiment.

FIG. 3 is an illustration of a simplified block diagram of a controller circuit in the near field communication enabled medical system of FIG. 2 in accordance with an embodiment.

FIG. 4 is a flowchart of a method for secure activation of a software feature, in accordance with an embodiment.

FIG. 5 is a peripheral illustration of a near field communication enabled medical system and a near field communication token, in accordance with an embodiment.

FIG. 6 is a flowchart of a method for secure activation of a software feature, in accordance with an embodiment.

FIG. 7 is an illustration of a portable host system, in accordance with an embodiment.

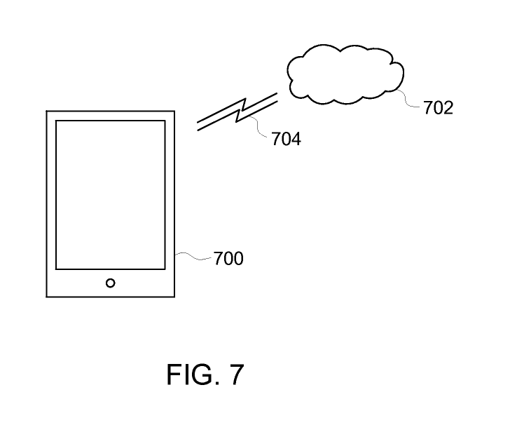

### DETAILED DESCRIPTION OF THE INVENTION

The following detailed description of certain embodiments will be better understood when read in conjunction with the appended drawings. To the extent that the figures illustrate diagrams of the functional blocks of various embodiments, the functional blocks are not necessarily indicative of the division between hardware circuitry. For example, one or more of the functional blocks (e.g., processors or memories) may be implemented in a single piece of hardware (e.g., a general purpose signal processor or a block of random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, the terms “system,” “unit,” or “module” may include a hardware and/or software system that operates to perform one or more functions. For example, a module, unit, or system may include a computer processor, controller, or other logic-based device that performs operations based on instructions stored on a tangible and non-transitory computer readable storage medium, such as a computer memory. Alternatively, a module, unit, or system may include a hard-wired device that performs operations based on hard-wired logic of the device. Various modules or units shown in the attached figures may represent the hardware that operates based on software or hardwired instructions, the software that directs hardware to perform the operations, or a combination thereof.

“Systems,” “units,” or “modules” may include or represent hardware and associated instructions (e.g., software stored on a tangible and non-transitory computer readable storage medium, such as a computer hard drive, ROM, RAM, or the like) that perform one or more operations described herein. The hardware may include electronic circuits that include and/or are connected to one or more logic-based devices, such as microprocessors, processors, controllers, or the like. These devices may be off-the-shelf devices that are appropriately programmed or instructed to perform operations described herein from the instructions described above. Additionally or alternatively, one or more of these devices may be hard-wired with logic circuits to perform these operations.

As used herein, an element or step recited in the singular and proceeded with the word “a” or “an” should be understood as not excluding plural of said elements or steps, unless such exclusion is explicitly stated. Furthermore, references to “one embodiment” of are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Various embodiments provide systems and methods that use Near Field Communication (NFC) tokens for secure activation of licenses and features on NFC enabled medical systems (e.g., ultrasound imaging systems). NFC tokens may be created by the medical system manufacturer, and support unidirectional and/or bi-directional communication between the NFC token and the medical system. Optionally, the activation of the license and/or feature may include a user entering a personal identification number (PIN) before and/or after the NFC communication unit receives the license key.

The NFC tokens may be within a small physical structure (e.g., a thumb drive, a tag, a card, a key ring, business card, company logo), a software application (e.g., on a tablet, a smart phone), or the like. As a software application, the NFC token may represent information within the software running on a mobile device (e.g., a portable host system). The software application may hold information about communication protocols and cryptographic information enabling secure non-interceptable communication between the mobile device and the medical system. It should be noted that other configurations of the NFC tokens may vary from those described herein.

Optionally, the NFC token may have a finite number of times that the NFC token may be used to activate features of medical systems. For example, the manufacturer may configure the NFC token to only be activated once, the NFC token may expire after a programmable amount of time or number of transmissions of the license key, or the like.

The NFC tokens hold license and/or feature activation information (e.g., license key), and are utilized by positioning the NFC token within a reception range or distance of a medical system (e.g., an ultrasound system) that includes or is communicatively coupled with an NFC communication unit. Optionally, the medical system may include an NFC communication area (e.g., a reception area of an NFC reader) exposed on an exterior of the medical system for easy access by users or service personnel. Support for the NFC communication unit, the NFC token, and the communication protocol between them may be implemented in the medical system either in software running on the medical system or in the medical system hardware, or a combination of both.

In at least one embodiment, the NFC token may automatically activate and transmit the license information (e.g., the license key) to the medical system when positioned within an NFC communication range of the medical system. Once the medical system receives the license information, the medical system may compare the received license information with licenses stored on a license database to determine whether the license information is valid. Once the license information is validated, corresponding software features are activated allowing the medical system to analyze data (e.g., ultrasound data) and/or enter operation modes based on the corresponding software feature, allow a user to access or interact with the corresponding software feature on the medical system, or the like. Optionally, the NFC tokens may establish a secure encrypted non-intercept communication with the medical system that prevents unauthorized copying/duplicating of license information exchanged between the NFC tokens and the medical system.

In at least one embodiment, the NFC token may not transmit any information until the medical system identifies itself to the NFC token, for example, using a cryptographic key. If the identification (e.g., manufacturer, model number, medical system version, serial number) of the medical system matches the identification programmed in the NFC token, the NFC token may transmit the license information to the medical system.

At least one technical effect of at least one embodiment includes a simplified process of activating licenses and/or features of a medical system relative to a user manually entering licensing keys. At least one technical effect of at least one embodiment includes an improved work-flow for the user to activate licenses and/or features of the medical system. At least one technical effect of at least one embodiment includes reducing the number of unauthorized copies and/or duplicates of license keys. At least one technical effect of at least one embodiment includes improving the cryptographic security of the license keys by leveraging storage capacity within the NFC tokens.

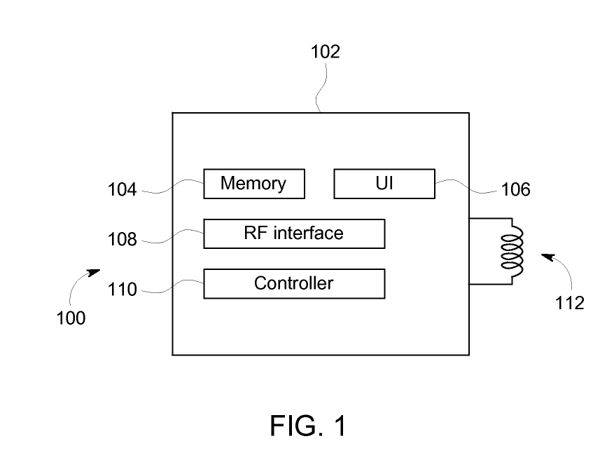

FIG. 1 illustrates a schematic diagram of a near field communication (NFC) token 100, in accordance to an embodiment. The NFC token 100 may include a memory device 104, a radio frequency (RF) interface 108, and an antenna 112. The RF interface 108 may be electrically coupled to the memory device 104 and the antenna 112. Optionally, the NFC token 100 may include a controller 110 and/or a user device 106. The components (e.g., the memory device 104, the RF interface 108, the antenna 122) may be enclosed within a housing 102. The housing 102 may be in the form of a keychain holder, a business card, a credit card, a thumb drive/memory stick, or the like.

The memory device 104 is an electronic storage device configured to store a license key. Additionally or alternatively, the memory device 104 may include a plurality of license keys. The contents of the memory device 104 may be accessed by the controller 110, the RF interface 108, or the like. The memory device 104 may include flash memory, RAM, ROM, EEPROM, or the like.

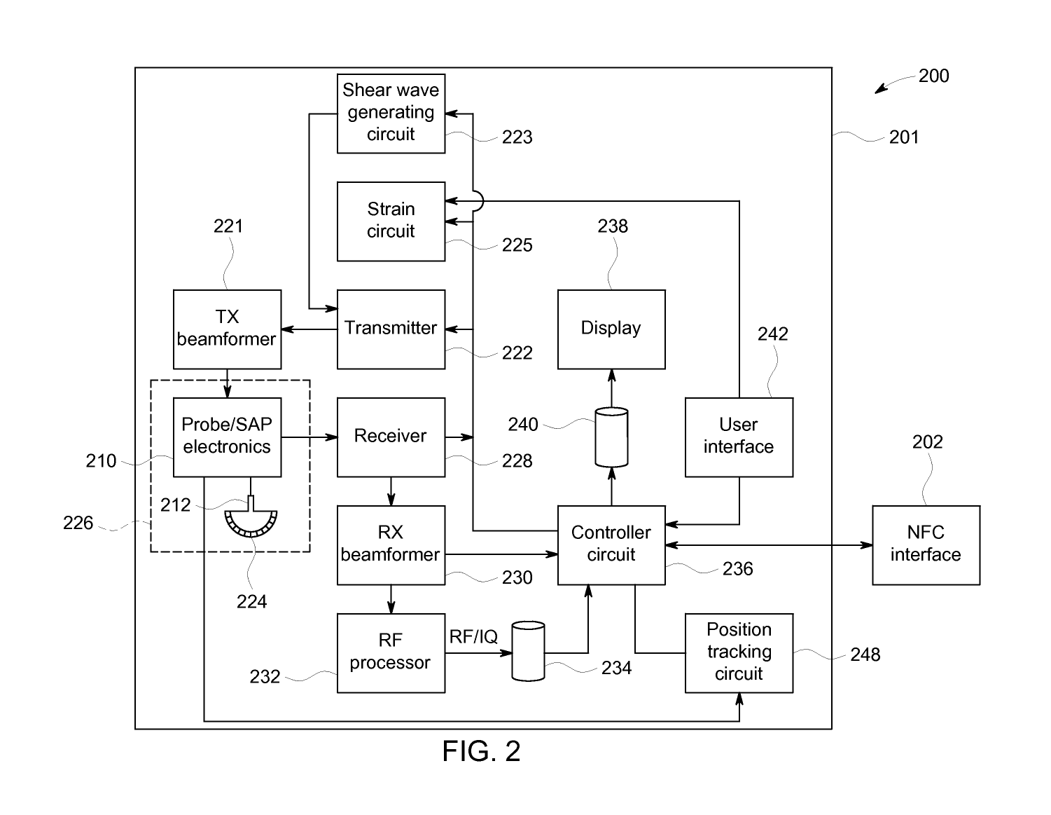

The license key is used by an NFC enabled medical system 200 (shown in FIG. 2) to activate a software feature of the NFC enabled medical system 200. The license key may include a string of characters (e.g., numerals, letters, punctuation symbols, control codes, spaces), for example, 128 characters in length. It should be noted that the license key may include more than or fewer than 128 characters in length. The license key may be based on proprietary or standard encoding schemes known in the art, such as, the American Standard Code for Information Interchange (ASCII). The license key may correspond to one or more software features of the NFC enabled medical system 200. Each software feature may correspond to an ultrasound mode, ultrasound data analysis process, user interface process, or the like, of the NFC enabled medical system 200. For example, the license key may correspond to four dimensional (4D) scanning for an ultrasound system.

The RF interface 108 may include a transmitter, a receiver, a transmitter and a receiver (e.g., a transceiver), or the like. The RF interface 108 may be configured to transmit information using an NFC protocol. Optionally, the RF interface 108 may be configured to receive information using the NFC protocol. The NFC protocol may be a short range wireless communication protocol defined in ISO/IEC 18092/ECMA-340, ISO/IEC 21481/ECMA-352, ISO/IEC 14443, or the like. The RF interface 108 may include hardware, such as a processor, controller, or other logic-based device to conform and/or encode information stored in the memory device 104 to the NFC protocol to transmit using the antenna 112, and/or decode information received by the antenna 112 to be processed by the RF interface 108 and/or the controller 110.

The antenna 112 may be configured to generate a current when positioned within an NFC activation field of the NFC enabled medical system 200. The current generated by the antenna 112 may supply power to the other components of the NFC token 100 (e.g., the memory device 104, the RF interface 108). Additionally or alternatively, the NFC token 100 may include a power source (not shown) that may be used to generate a token NFC activation field. For example, the antenna 112 may emit a small electric current, supplied by the power source, which creates a magnetic field propagating through an area that defines the token NFC activation field.

The antenna 112 is electrically coupled to the RF interface 108 allowing the NFC token 100 to transmit information from the NFC token 100 to the NFC enabled medical system 200. Additionally or alternatively, the antenna 112 allows the NFC token 100 to receive identification information from the NFC enabled medical system 200. The identification information may be used by the NFC token 100 to authorize transmission of the license key to the NFC enabled medical system 200. The identification information may include, for example, a user personal identification number (PIN), a serial number, a manufacturer identification, a purchase confirmation number, or the like.

The controller 110 may control the operation of the NFC token 100. The controller 110 may be embodied in hardware, such as a processor, controller, or other logic-based device, that performs functions or operations based on one or more sets of instructions (e.g., software). The instructions on which the hardware operates may be stored on a tangible and non-transitory (e.g., not a transient signal) computer readable storage medium, such as the memory device 104. Alternatively, one or more of the sets of instructions that direct operations of the hardware may be hard-wired into the logic of the hardware. The controller 110 may be used to instruct the RF interface to transmit an identification request and verify the identification information received by the NFC token 100. For example, the controller 110 may compare the identification information received from the NFC medical system 200 with identification information stored on the memory device 104.

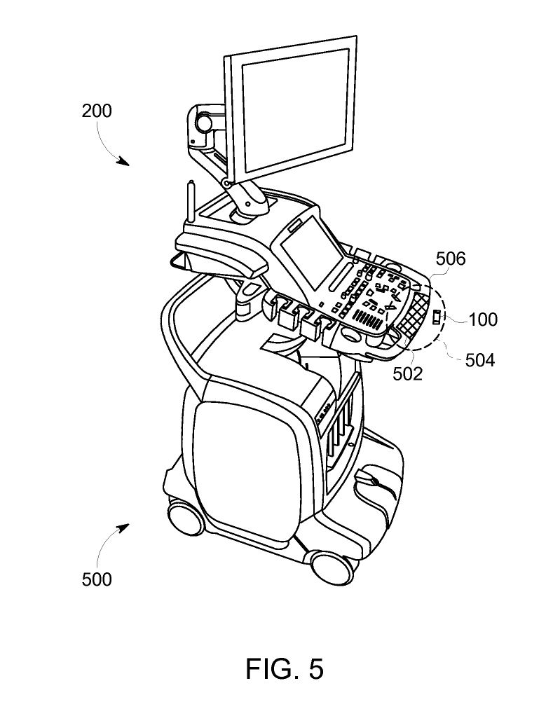

The user input device 106 may include a switch, a relay, a tactile button, or the like. The user input device 106 may be used by the RF interface 108 to determine when to transmit the transmit information. For example, the NFC token 100 may be placed within the NFC activation field 504 (shown in FIG. 5) of the NFC enabled medical system 200 to supply power to the NFC token 100. The NFC activation field 504 may correspond to a region where a magnetic field generated by the NFC enabled medical system 200 can be received by the antenna 112. While the NFC token 100 is passed through the NFC activation field 504 and/or held or placed within the NFC activation field 504, the NFC token 100 and the NFC enabled medical system 200 are enabled to communicate (e.g., establish communication) using the NFC protocol. Once the NFC token 100 is within the NFC activation field a user may activate the user input device 106, which instructs the RF interface 108 to transmit the transmit information stored in the memory device 104.

Optionally, the user input device 106 may be configured to only be activated a finite number of times (e.g., once, twice), such as for a limited use license. For example, if the user attempts to activate the user input device 106 after the finite number of times the RF interface 108 will no longer transmit the transmit information.

FIG. 2 is a schematic diagram of the NFC enabled medical system 200, in accordance with an embodiment. The NFC enabled medical system 200 may include an ultrasound imaging system 201, for example, such as the ultrasound imaging system described in U.S. Publication 2014/0180109, entitled “ULTRASOUND SERVICING SYSTEM AND METHOD,” which is expressly incorporated herein in its entirety. In at least one embodiment, the ultrasound imaging system 201 includes an ultrasound probe 226 having a transmitter 222 and probe/SAP electronics 210. The transmitter 222 transmits a signal to a transmit beamformer 221 which in turn drives the transducer elements 224 within the transducer array 212. The transducer elements 224 emit pulsed ultrasonic signals into a patient (e.g., a body). A variety of a geometries and configurations may be used for the array 212. Further, the array 212 of transducer elements 224 may be provided as part of, for example, different types of ultrasound probes.

The transducer elements 224, for example piezoelectric crystals, emit pulsed ultrasonic signals into a body (e.g., patient) or volume. The ultrasonic signals may include, for example, one or more reference pulses, one or more pushing pulses (e.g., shear-waves), and/or one or more tracking pulses. At least a portion of the pulsed ultrasonic signals back-scatter from a region of interest (ROI) (e.g., breast tissues, liver tissues, cardiac tissues, prostate tissues, and the like) to produce echoes. The echoes are delayed in time according to a depth, and are received by the transducer elements 224 within the transducer array 212. The ultrasonic signals may be used for imaging, for generating and/or tracking shear-waves, for measuring differences in compression displacement of the tissue (e.g., strain), and/or for therapy, among other uses. For example, the probe 226 may deliver low energy pulses during imaging and tracking, medium to high energy pulses to generate shear-waves, and high energy pulses during therapy.

The transducer array 212 may have a variety of array geometries and configurations for the transducer elements 224 which may be provided as part of, for example, different types of ultrasound probes. The probe/SAP electronics 210 may be used to control the switching of the transducer elements 224. The probe/SAP electronics 210 may also be used to group the transducer elements 224 into one or more sub-apertures.

The transducer elements 224 convert the received echo signals into electrical signals which may be received by a receiver 228. The electrical signals representing the received echoes are passed through a receive beamformer 230, which performs beamforming on the received echoes and outputs a radio frequency (RF) signal. The RF signal is then provided to an RF processor 232 that processes the RF signal. Alternatively, the RF processor 232 may include a complex demodulator (not shown) that demodulates the RF signal to form IQ data pairs representative of the echo signals. The RF or IQ signal data may then be provided directly to a memory 234 for storage (e.g., temporary storage). Optionally, the output of the beamformer 230 may be passed directly to a controller circuit 236.

The ultrasound imaging system 201 also includes a processor or the controller circuit 236 to process the acquired ultrasound information (e.g., RF signal data or IQ data pairs) and prepare frames of ultrasound information for display on the display 238. The controller circuit 236 may include one or more separate processing components. For example, the controller circuit 236 may include a central processing unit (CPU), a microprocessor, a graphics processing unit (GPU), or any other electronic component capable of processing inputted data according to specific logical instructions. Having the controller circuit 236 that includes a GPU may be advantageous for computation-intensive operations, such as volume-rendering.

The controller circuit 236 is adapted to perform one or more processing operations according to a plurality of selectable ultrasound modalities on the acquired ultrasound information. Acquired ultrasound information may be processed in real-time during a scanning or therapy session as the echo signals are received. Additionally or alternatively, the ultrasound information may be stored temporarily in the memory 234 during a scanning session and processed in less than real-time in a live or off-line operation.

The ultrasound imaging system 201 may include a memory 240 for storing processed frames of acquired ultrasound information that are not scheduled to be displayed immediately or to store post-processed images (e.g., shear-wave images, strain images). The memory device 104 may include flash memory, RAM, ROM, EEPROM, or the like.

Additionally or alternatively, the memory 240 may include a license key database. The license key database may include a plurality of license keys with a corresponding software feature of the ultrasound imaging system 201. Each of the license keys on the database may have a unique string of characters. The license key database may be used by the controller circuit 236 to compare the one or more license keys, received from the transmit information transmitted from the NFC token 100, to one or more corresponding software features to be activated by the controller circuit 236. For example, the controller circuit 236 may receive a license key from the NFC token 100 through the NFC interface 202. The received license key may authorize the ultrasound imaging system 201 to perform 4D scanning of the patient. The controller circuit 236 compares the received license key with the license keys stored on the license key database to determine whether the received license key is valid (e.g., matches a license key stored on the database), and if valid which software features(s) to activate. When the controller circuit 236 matches the received license key with one of the license key stored on the license key database, the controller circuit 236 may activate or enable the software feature corresponding to the stored license key.

Optionally, the memory 240 may include a license key algorithm that the controller circuit 236 is configured to execute. The license key algorithm may be used to verify the license key and determine which software feature corresponds to the license key received from the transit information. For example, the controller circuit 236 may receive a license key from the NFC token 100 through the NFC interface 202. The controller circuit 236 executes the license key algorithm based on the received license key resulting in a decoded license key. If the received license key is valid, the decoded license key can be interpreted by the controller circuit 236 to correspond to one or more software features. If the received license key is not valid, the decoded license key may not be interpreted by the controller circuit 236 to a corresponding software feature(s) and may be ignored by the controller circuit 236.

The position tracking circuit 248 tracks a position of the probe 226 and communicates the position to the controller circuit 236 as described above. Optionally, the controller circuit 236 may associate or correlate the ROI data acquisition location of the probe 226 with the acquisition of data corresponding to the SEI and/or SWEI, respectively, in the image memory 240.

The controller circuit 236 is connected to a user interface 242 that controls operation of the controller circuit 236 and the display 238 as explained below in more detail and is configured to receive inputs from the user, for example a keyboard, a keypad, buttons, a touchscreen. The display 238 may include one or more monitors that present patient information, including diagnostic and therapeutic ultrasound images to the user for review, diagnosis, analysis, and treatment. The display 238 may automatically display, for example, one or more 2D, 3D, or 4D ultrasound data sets stored in the memory 234 or 240 or currently being acquired. One or both of the memory 234 and the memory 240 may store 3D data sets of the ultrasound data (e.g., shear-wave data, strain data), where such 3D data sets are accessed to present 2D and 3D images. For example, a 3D ultrasound data set may be mapped into the corresponding memory 234 or 240, as well as one or more reference planes. The processing of the data, including the data sets, may be based in part on user inputs, for example, user selections received at the user interface 242.

The controller circuit 236 is configured to analyze ultrasound signals to obtain the SEI and/or SWEI of the ROI. Furthermore, the controller circuit 236 may also automatically differentiate tissue of the ROI from non-ROI tissue. The controller circuit 236 may also be configured to receive user imaging commands for highlighting or outlining the image, a display layout (e.g., side-by-side, overlaid), or otherwise providing an overlay that indicates the ROI within the SEI and/or SWEI.

The controller circuit 236 may be configured to control the probe 226 by having the probe 226 enter into diagnostic or imaging modes such as a shear-wave mode or a strain mode. For example, the controller circuit 236 may control the probe 226 to enter the shear-wave mode. Once the probe 226 is in the shear-wave mode, the probe 226 may be controlled to deliver a pushing pulse to generate a shear-wave within the ROI automatically within a predetermined time frame or by the user using the user interface 242.

In operation, the ultrasound imaging system 201 acquires data, for example, volumetric data sets by various techniques (e.g., 3D scanning, real-time 3D imaging, volume scanning, 2D scanning with transducers having positioning sensors, freehand scanning using a voxel correlation technique, scanning using 2D or matrix array transducers, or the like). The data may be acquired by moving the probe 226, such as along a linear or curvilinear path, while scanning the ROI. At each linear or arcuate position, the probe 226 obtains scan planes that are stored in the memory 234.

The ultrasound imaging system 201 may include a shear-wave-generating circuit 223 that is operatively coupled to the controller circuit 236 or a sub-circuit of the controller circuit 236. The shear-wave generating circuit 223 is configured to control the probe 226 when the probe 226 is operated in a shear-wave mode. While in the shear-wave mode, the shear-wave generating circuit 223 may control the probe 226 to generate a shear wave at a site within the ROI of the patient. The shear-wave-generating circuit 223 may control the probe 226 or, more particularly, the transducer elements 224 to direct a shear-wave generating or pushing pulse(s) toward the predetermined site to generate the shear-wave. Alternatively, the shear-wave generating circuit 223 may control another device capable of generating shear-waves having the probe 226 measure or track the velocity as the shear-wave passes through the ROI. For example, the shear-wave-generating circuit 223 may control a therapy transducer, a mechanical actuator, or an audio device to generate the shear waves.

The ultrasound imaging system 201 also includes a strain circuit 225 that is operatively coupled to the controller circuit 236 or a sub-circuit of the controller circuit 236. The strain circuit 225 is configured to control the probe 226 when the probe 226 operated in a strain mode. While in the strain mode, the strain circuit 225 may control the probe 226 to generate a mechanical (e.g., surface vibration, freehand or step quasi-static surface displacement, or the like) or radiation force on the patient or ROI to measure the stiffness or strain of the ROI of the patient. Alternatively, the strain circuit 225 may control another device capable of generating a mechanical force on the patient or the ROI. For example, a low frequency mechanical vibrator may be applied to the skin surface and the compression motion induced in the underlying tissue, such as on the ROI, is measured by the probe 226.

The ultrasound imaging system 201 also includes an NFC interface 202. The NFC interface 202 is configured to receive information from the NFC token 100. The NFC interface 202 may also be adapted to emit an electric current to an antenna (not shown), which creates a magnetic field that defines the NFC activation field. The NFC activation field may extend up to a distance of about twenty centimeters from the NFC interface 202. It should be appreciated, however that the NFC activation field may be greater than or less than twenty centimeters. For example, in one embodiment, the NFC activation field extends about ten centimeters, while in another embodiment the NFC activation field extends four centimeters. The NFC activation field may represent the affective area the magnetic field generated by the NFC interface 202 can be used to power the NFC token 100 when received by the antenna 112. Additionally or alternatively, the NFC activation field may represent the effective area the NFC interface 202 can receive transmit information from the NFC token 100.

Once the transmit information is received by the NFC interface 202, the NFC interface 202 may output the transmit information to the controller circuit 236. The controller circuit 236 may partition the license key from the transmit information and compare the received license key to the license key stored on the license key database and memory 240. Additionally or alternatively, the controller circuit 236 may execute the license key algorithm to determine which software feature corresponds to the received license key.

In at least one embodiment, the ultrasound imaging system 201 may transmit information from the NFC interface 202 to the NFC token 100. The transmit information from the NFC interface 202 may include identification information of the ultrasound imaging system 201 and/or the user of the ultrasound imaging system 201. The identification information may include a user PIN, a serial number, a manufacturer identification, a purchase confirmation number, or the like.

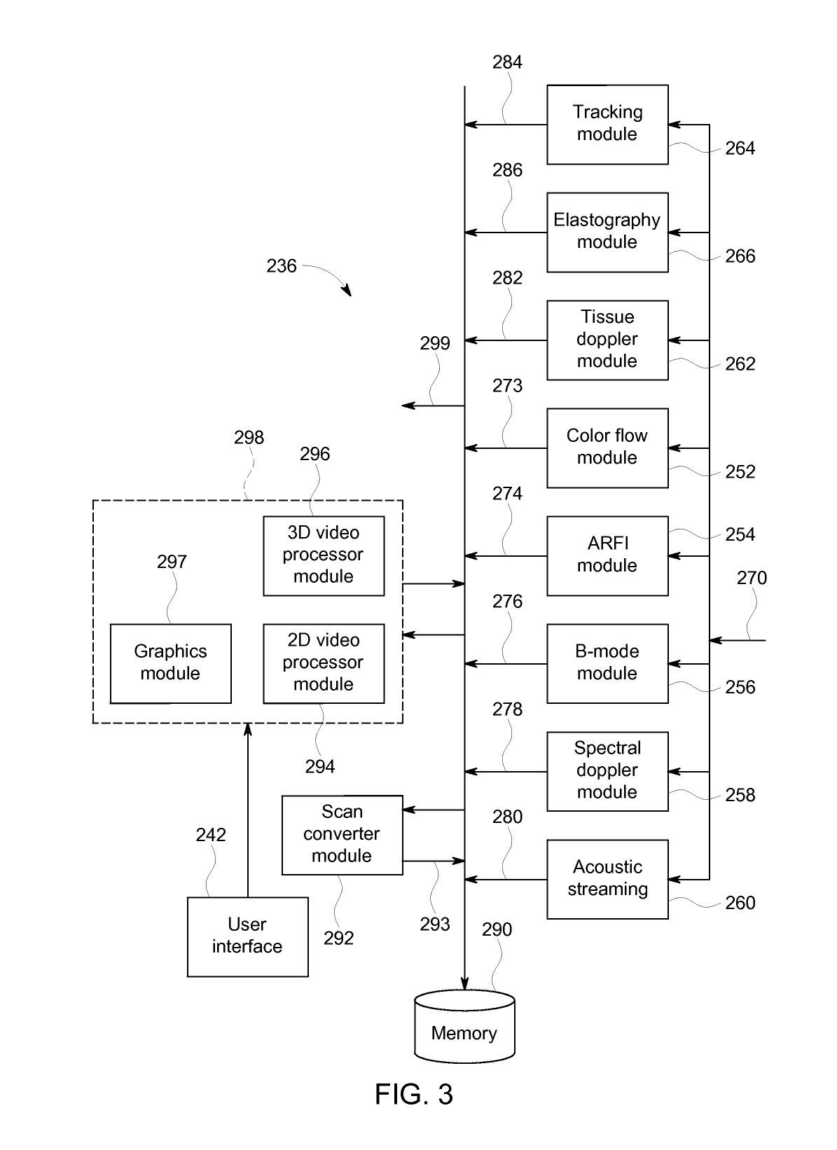

FIG. 3 is an exemplary block diagram of the controller circuit 236. The controller circuit 236 is illustrated in FIG. 3 conceptually as a collection of circuits, but may be implemented utilizing any combination of dedicated hardware boards, DSPs, one or more processors, or the like. Alternatively, the circuit 236 may be implemented utilizing an off-the-shelf PC with a single processor or multiple processors, with the functional operations distributed between the processors. As a further option, the circuit 236 may be implemented utilizing a hybrid configuration in which certain modular functions are performed utilizing dedicated hardware, while the remaining modular functions are performed utilizing an off-the-shelf PC and the like. The circuit 236 also may be implemented as software circuits within a processing unit.

The circuits 252-266 perform mid-processor operations representing one or more software features of the ultrasound imaging system 201. The controller circuit 236 may receive ultrasound data 270 in one of several forms. In the embodiment of FIG. 3, the received ultrasound data 270 constitutes IQ data pairs representing the real and imaginary components associated with each data sample. The IQ data pairs are provided to one or more circuits, for example, a color-flow circuit 252, an acoustic radiation force imaging (ARFI) circuit 254, a B-mode circuit 256, a spectral Doppler circuit 258, an acoustic streaming circuit 260, a tissue Doppler circuit 262, a tracking circuit 264, and an elastography circuit 266. Other circuits may be included, such as an M-mode circuit, power Doppler circuit, among others. However, embodiments described herein are not limited to processing IQ data pairs. For example, processing may be done with RF data and/or using other methods. Furthermore, data may be processed through multiple circuits.

Each of circuits 252-266 is configured to process the IQ data pairs in a corresponding manner to generate, respectively, color-flow data 273, ARFI data 274, B-mode data 276, spectral Doppler data 278, acoustic streaming data 280, tissue Doppler data 282, tracking data 284 (e.g., ROI data acquisition location), elastography data 286 (e.g., strain data, shear-wave data), among others, all of which may be stored in a memory 290 (or memory 234 or memory 240 shown in FIG. 2) temporarily before subsequent processing. The data 273-286 may be stored, for example, as sets of vector data values, where each set defines an individual ultrasound image frame. The vector data values are generally organized based on the polar coordinate system.

A scan converter circuit 292 accesses and obtains from the memory 290 the vector data values associated with an image frame and converts the set of vector data values to Cartesian coordinates to generate an ultrasound image frame 293 formatted for display. The ultrasound image frames 293 generated by the scan converter circuit 292 may be provided back to the memory 290 for subsequent processing or may be provided to the memory 234 or the memory 240. Once the scan converter circuit 292 generates the ultrasound image frames 293 associated with the data, the image frames may be stored in the memory 290 or communicated over a bus 299 to a database (not shown), the memory 234, the memory 240, and/or to other processors (not shown).

The display circuit 298 accesses and obtains one or more of the image frames from the memory 290 or from the memory 234 and/or the memory 240 over the bus 299 to display the images onto the display 238. The display circuit 298 receives user input from the user interface 242 selecting one or image frames to be displayed that are stored on memory (e.g., the memory 290) and/or selecting a display layout or configuration for the image frames.

The display circuit 298 may include a 2D video processor circuit 294. The 2D video processor circuit 294 may be used to combine one or more of the frames generated from the different types of ultrasound information. Successive frames of images may be stored as a cine loop (4D images) in the memory 290 or memory 240. The cine loop represents a first in, first out circular image buffer to capture image data that is displayed in real-time to the user. The user may freeze the cine loop by entering a freeze command at the user interface 242. The user interface 242 may include, for example, a keyboard and mouse and all other input controls associated with inputting information into the ultrasound imaging system 201. In one embodiment, the user interface 242 includes the display 238 that may be touch-sensitive or configured to interact with a stylus. The user interface 242 may also receive user inputs through voice-recognition or activation.

The display circuit 298 may include a 3D processor circuit 296. The 3D processor circuit 296 may access the memory 290 to obtain spatially consecutive groups of ultrasound image frames and to generate three-dimensional image representations thereof, such as through volume rendering or surface rendering algorithms as are known. The three-dimensional images may be generated utilizing various imaging techniques, such as ray-casting, maximum intensity pixel projection and the like.

The display circuit 298 may include a graphic circuit 297. The graphic circuit 297 may access the memory 290 to obtain groups of ultrasound image frames and the ROI data acquisition locations that have been stored or that are currently being acquired. The graphic circuit 297 may generate images that include the images of the ROI and a graphical representation positioned (e.g., overlaid) onto the images of the ROI. The graphical representation may represent an outline of a treatment space, the focal point or region of the therapy beam, a path taken by the focal region within the treatment space, a probe used during the session, the ROI data acquisition location, and the like. Graphical representations may also be used to indicate the progress of the therapy session. The graphical representations may be generated using a saved graphical image or drawing (e.g., computer graphic generated drawing), or the graphical representation may be directly drawn by the user onto the image using a pointing device, e.g., an electronic stylus or mouse, or another interface device.

Each of the circuits 252-266 and portions of the display circuit 298 may represent various software features that may be activated in a factory default mode or only activated once a corresponding license key is received by the ultrasound imaging system 201. For example, the ultrasound imaging system 201 may be configured with the factory default configuration when shipped from the manufacturer or received by the user. The factory default configuration may include a selection of software features that are active on the ultrasound imaging system 201 without the need for a license key. While in the factory default configuration, for example, the controller circuit 236 may restrict which circuits 252-266 and/or modules 294, 296-297 are enabled to receive ultrasound data, process ultrasound data, accessible to the user using the user interface 242, or the like.

Optionally, the software features may be activated for a predetermined amount of time (e.g., thirty days, ninety days) defining a trial time period. For example, the trial time period may be based on the first activation of the ultrasound imaging system 201 until the ultrasound imaging system 201 has been used and/or activated for the predetermined amount of time. During the trial time period the controller circuit 236 may have all software features (e.g., circuits 252-266, modules 294, 296-297) enabled. Once the trial time period is over, the controller circuit 236 may deactivate the software features reverting to a factory default configuration, unless a corresponding license key was received to enable or activate one or more of the software features.

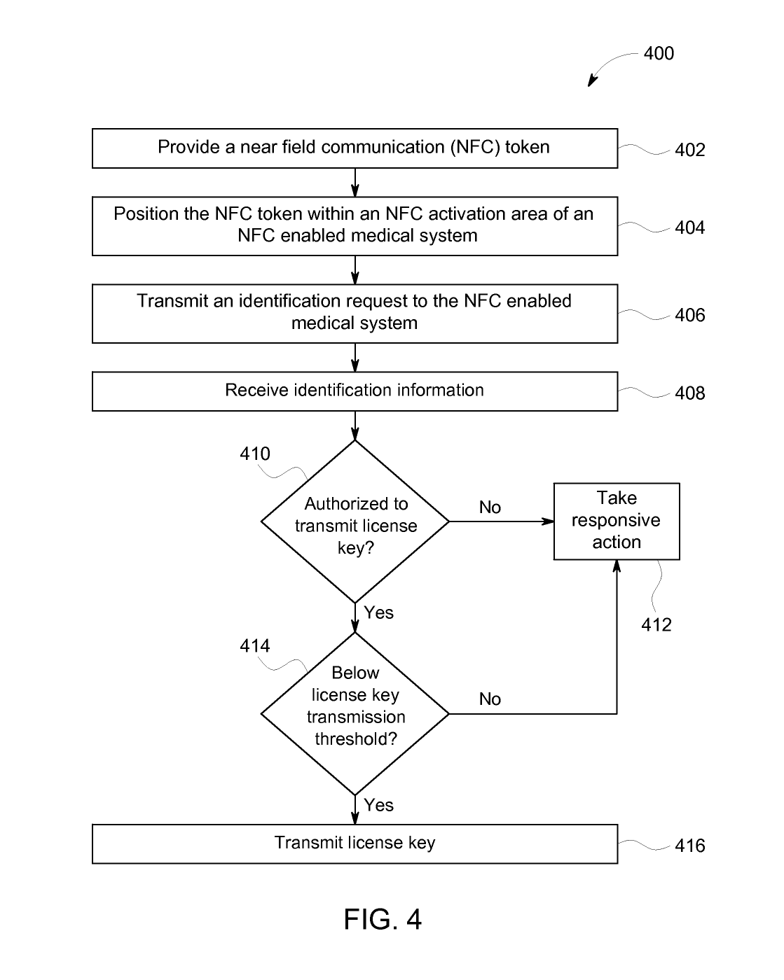

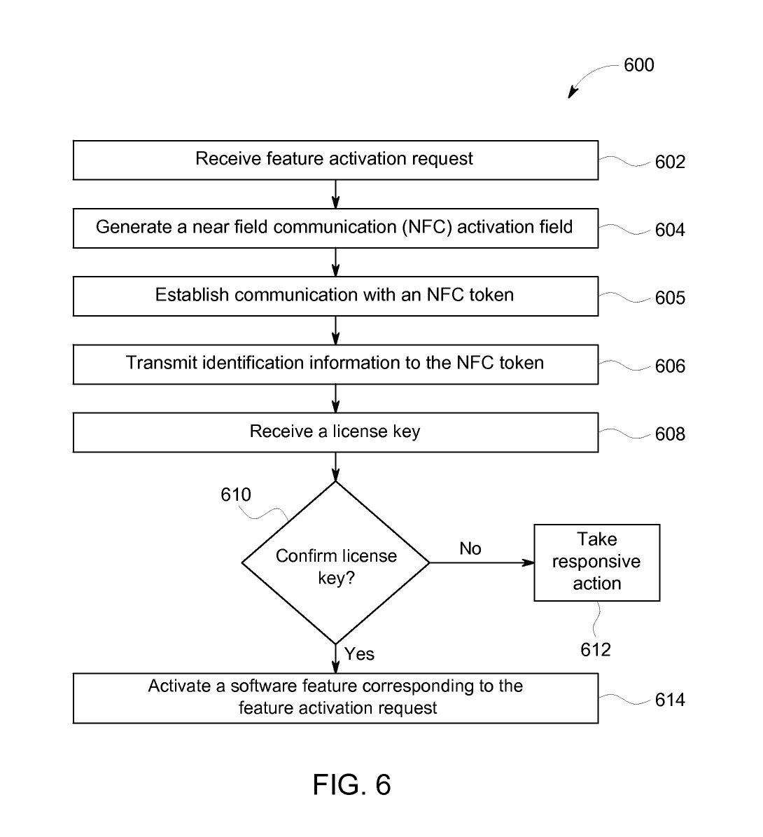

FIGS. 4 and 6 illustrates flowcharts of methods 400 and 600, respectively, for secure activation of a software feature, in accordance with various embodiments described herein. The methods 400 and 600, for example, may employ structures or aspects of various embodiments (e.g., systems and/or methods) discussed herein (e.g., the NFC token 100 in FIG. 1, the NFC enabled medical system 200 in FIG. 2). In various embodiments, certain steps (or operations) may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion. In various embodiments, portions, aspects, and/or variations of the methods 400 and 600 may be used as one or more algorithms to direct hardware to perform one or more operations described herein. It should be noted, other methods may be used, in accordance with embodiments herein.

One or more methods may (i) provide a near field communication (NFC) token, (ii) position the NFC token within an NFC activation field of an NFC enabled medical system, and, (iii) transmit a license key.

Beginning at 402, the method 400 provides the NFC token 100. For example, the NFC token 100 may be provided by a manufacturer of the NFC enabled medical system 200 in response to a software feature request form a user.

At 404, the NFC token 100 is positioned within an NFC activation field 504 of the NFC enabled medical system. FIG. 5 shows a peripheral view 500 of the NFC enabled medical system 200 and the NFC token 100, in accordance with an embodiment. The NFC activation field 504 is illustrated as an outlined area. The NFC activation field 504 may be defined by the magnetic field generated by the NFC interface 202, corresponding to a region where the magnetic field of the NFC interface 202 can be received or detected by the antenna 112 of the NFC token 100. While the antenna 112 is within the NFC activation field 504, the antenna 112 may supply power to the components of the NFC token 100. When the NFC token 100 is passed through the NFC activation field 504 and/or held or placed within the NFC activation field 504 by the user, the NFC token 100 and the NFC enabled medical system 200 are enabled to communicate (e.g., establish communication) using the NFC protocol.

Optionally, the NFC enabled medical system 200 may include an NFC reader 502 corresponding to an area of a housing 506 of the NFC enabled medical system 200. The NFC reader 502 may be located proximate to and/or within the NFC activation field 504. Additionally or alternatively, the NFC reader 502 may integrated with the NFC interface 202. The NFC reader 502 may be configured to aid the user in positioning the NFC token 100 relative to the NFC enabled medical system 200 to initiate communication. Optionally, the NFC reader 502 may include a platform such that the NFC token 100 may be placed atop of the NFC reader 502. In another embodiment, the NFC reader 502 may include a holder shaped to receive the NFC token 100. Additionally or alternatively, the NFC reader 502 may be identified by markings (e.g., a color, arrows, labels) on the housing 506. It should be appreciated these are simply exemplary embodiments of the NFC reader 502 and that other embodiments may be envisioned. When the NFC token 100 is placed within a reception range of the NFC reader 502 by the user, the NFC token 100 and NFC enabled medical system 200 are unable to communicate using the NFC protocol.

At 406, the method 400 may transmit an identification request to the NFC enabled medical system 200. For example, the NFC token 100 may request the identification request to the NFC enabled medical system 200 once communication has been established. The identification request may be used by the NFC token 100 to verify that the NFC enabled medical system 200 is authorized to receive the license key. Optionally, the identification request may be specific towards identification information that includes a user PIN, a serial number, a manufacturer identification, a purchase confirmation number, or the like, from the NFC enabled medical system 200.

In at least one embodiment, the NFC token 100 may transmit the identification request once the user input device 106 is activated. For example, once the user positions the NFC token 100 within the NFC activation field 504, the user may activate user input device 106 to instruct the NFC token 100 to transmit the identification request.

The identification request may be received by the NFC enabled medical system 200 through the NFC interface 202. The identification information may be stored on the memory 240, which may be retrieved by the controller circuit 236. The identification information may include a serial number, manufacturer identification, or the like. Optionally, the controller circuit 236 may request the identification information from the user by displaying a prompt on the display 238, such as requesting the user PIN, the purchase confirmation number, or the like. The user may enter the requested identification information using the user interface 242, which will be received by the controller circuit 236. Once the identification information is received from the user and/or retrieved from the memory 240, the controller circuit 236 may instruct the NFC interface 202 to transmit the identification information to the NFC token 100

At 408, the method 400 may receive identification information. The identification information may be received by the antenna 112 of the NFC token 100 from the NFC enabled medical system 200.

Once the identification information is received by the NFC token 100, at 410, the method 400 determines whether the NFC token 100 is authorized to transmit the license key to the NFC enabled medical system 200. The authorized identification information may be stored on the memory 104 of the NFC token 100. The controller 110 may compare the received identification information from the NFC enabled medical system 200 with the authorized identification information stored on the memory 104. If the received identification information matches a corresponding authorized identification information, the NFC token 100 is authorized to transmit the license key.

If the NFC enabled medical system 200 is authorized to receive the license key, at 414, the method 400 may determine whether the NFC token 100 has reached a license key transmission threshold. The license key transmission threshold may correspond to a finite number of license keys that the NFC token 100 may transmit. The license key transmission threshold may be a predetermined amount stored on the memory 104. After each transmission of the license key, the controller 110 may increment a transmission counter stored on the memory 104. The controller 110 may compare the value of the transmission counter with the predetermined amount stored on the memory 104. If the value of the transmission counter is lower than the predetermined amount, the controller 110 may determine that the license key transmission threshold has not been reached.

If the license key transmission threshold has not been reached, at 416, the method 400 transmits the license key. For example, the NFC token 100 may transmit the license key stored on the memory 104 via the RF interface 108 and the antenna 112. In at least one embodiment, the NFC token 100 may transmit the license key once the user input device 106 is activated. For example, once the user positions the NFC token 100 within the NFC activation field 504, the user may activate user input device 106 to instruct the NFC token 100 to transmit the license key.

If the NFC enabled medical system 200 is not authorized to receive the license key and/or the license key transmission threshold has been reached, at 412, the method 400 may take a responsive action(s). For example, the NFC token 100 may transmit an error message to the NFC enabled medical system 200. Optionally, the NFC token 100 may retransmit an identification request to the NFC enabled medical system. In at least one embodiment, the NFC token 100 may display an error message (e.g., activate an LED on the housing 102).

One or more methods may (i) receive a feature activation request, (ii) generate a near field communication (NFC) activation area, (iii) transmit identification information to an NFC token, (iv) receive a license key, and (v) activate a corresponding software feature.

Beginning at 602, the method 600 receives a feature activation request. For example, the user using the user interface 242 may input a request corresponding to the feature activation request, which is received by the controller circuit 236. The feature activation request may correspond to enabling or activating one or more software features of the NFC enabled medical system 200, which are currently not enabled by the controller circuit 236. Additionally or alternatively, the feature activation request may correspond to one or more software features that are currently enabled during the trial time period, which the user requests to be enabled after the trial time period expires.

At 604, the method 600 generates the NFC activation field 504. For example, once the feature activation request is received by the controller circuit 236, the controller circuit 236 may instruct the NFC interface 202 to generate a magnetic field corresponding to the NFC activation field 504.

At 605, the method 600 may establish communication with an NFC token 100. For example, communication may be established when the user places the NFC token 100 across and/or within the NFC activation field 504. Optionally, communication may be established when the user places the NFC token 100 within a reception range of the NFC reader 502.

At 606, the method 600 may transmits identification information to the NFC token 100. For example, the controller circuit 236 may instruct the NFC interface 202 to transmit the identification information stored in memory 240. The identification information may include a user PIN, a serial number, a manufacturer identification, or purchase confirmation number. The identification information may correspond to a unique string of characters generated for the NFC enabled medical system 200 to be identified by the NFC token 100.

Additionally or alternatively, the identification information may correspond to a unique string of characters generated for the user of the NFC enabled medical system 200 to be identified by the NFC token 100 and/or the NFC enabled medical system 200. For example, after the user inputs the feature activation request using the user interface 242 the NFC enabled medical system 200 may prompt the user to enter identification information. Once the identification information is received from the user interface 242, the controller circuit 236 may compare the identification information with authorize identification information stored on the memory 240. If the user is authorized, for example, the identification information matches the authorized identification information stored on the memory 240, the controller circuit 236 may instruct the NFC interface 202 to transmit a go-ahead or a proceed signal to the NFC token 100. In at least one embodiment, if the user is authorized the NFC enabled medical system 200 may proceed with the software activation once the license key is received and verified.

At 608, the method 600 receives the license key. For example, once the NFC token 100 receives and verifies the identification information, the NFC token 100 may transmit the license key to the NFC enabled medical system 200, which may be received by the NFC interface 202. Additionally or alternatively, the NFC enabled medical system 200 may receive the license key once communication is established with the NFC token 100.

At 610, the method 600 confirms the license key. For example, the controller circuit 236 may compare the license key to authorized or valid license keys stored on the memory 242 to confirm whether the license key corresponds to the feature software of the feature activation request. Additionally alternatively, the controller circuit 236 may confirm the license key using the license key algorithm.

If the license key is confirmed, at 614, the method 600 activates the software feature corresponding to the feature activation request. For example, the user inputs a feature activation request using the user interface 242 for the software feature corresponding to 3D video of ultrasound date. The controller circuit 236 compares the license key, received from the NFC token 100, with the license keys stored on the license key database that correspond to activating the 3D video of ultrasound data. Once the controller circuit 236 determines that that license keys match (e.g., confirms the license key), the controller circuit 236 may enable or activate the 3D video processor module 296. Once activated, the 3D video processor module 296 may access the memory 292, generate 3D image representations of ultrasound image frames, accessible to the user using the user interface 242, or the like.

If the license key is not confirmed, at 612, the method 600 takes responsive action. For example, an error message may be displayed on the display 238, the NFC enabled medical system 200 may prompt the user to reposition the NFC token 100, or the like.

Additionally or alternatively, the NFC token may include a portable host system 700. The portable host system 700 may be in communication and/or electrically coupled to the RF interface 108, the memory device 104, and the antenna 112. The portable host system 700 may constitute a smart phone, an electronic tablet, a portable computer, or the like. The portable host system 700 may be configured to perform non-medical applications that may be utilized by the portable host system 700. For example, the primary function of the portable host system 700 may be to enable a user to transmit and receive information as a phone or over the Internet. The portable host system 700 may enable the user to download and operate a variety of non-medical applications that may be utilized by the portable host system 700 (e.g., browse the internet, take photos, play music, map functions).

Optionally, the portable host system 700 may be used by the user to receive and/or download the license key from a remote location 702 to be used by the NFC token 100. The portable host system 700 may include a transceiver configured to receive the license key from the remote location 702 using wireless (e.g., WiFi, 802.11, Bluetooth) and/or wired (e.g., Ethernet) communication protocols 704. For example, the user may purchase the license key using an internet browser, medical application store, internet store supported by the manufacturer of the NFC enabled medical system 200, or the like. Once the license key is received by the portable host system 700, the license key may be stored on the memory 104 by the portable host system 700 and/or the controller 110.

Optionally, the user may receive identification information from the remote location once the license key is purchase, such as, the user may receive a purchase confirmation number, a user PIN, or the like.

In one example of the inventive subject matter, a near Field communication (NFC) token 100 includes an antenna 112, and a memory device 104 configured to store a license key. The license key is used by an NFC enabled medical system 200 to activate a software feature of the NFC enabled medical system 200. The NSC token 100 includes a transmitter (e.g., the RF interface 108) logically coupled to the antenna 112 and the memory device 104. The transmitter is configured to transmit information to the NFC enabled medical system 200 when the transmitter is within an NFC activation field 504 of the NFC enabled medical system 200. The transmit information includes the license key.

In one aspect, the NFC token 100 may include a receiver coupled to the antenna 112 and the memory device 104. The receiver may be configured to receive information from the NFC enabled medical system 200.

In one aspect, the transmit information may be transmitted by the NFC token 100 was the receiver receives identification information from the NFC enabled medical system 200. The identification information may include at least one of a user PIN, a serial number, a manufacturer identification, or a purchase confirmation number.

In one aspect, the NFC token 100 may include a housing 102. The housing 102 may enclose the memory device 104, the antenna 112, and the transmitter. Optionally, the housing 102 may include a user input device 106 such that the transmit information is transmitted by the NFC token 100 once the user input device 106 is activated.

In one aspect, the NFC token 100 may include a portable host system 700. The portable host system 700 is in communication with the memory device 104. The portable host system includes a transceiver configured to receive the license key from a remote location 702. Optionally, the portable host system 700 may constitute a smart phone or an electronic tablet.

In one aspect, the NFC enabled medical system 200 may include a user interface 242 such that the software feature is activated by the NFC enabled medical system 200 when the identification information is received from the user interface 242.

In one aspect, the NFC activation field 504 is positioned within a reception range of an NFC reader 502 of the NFC enabled medical system.

In one example of the inventive subject matter, a method includes providing a near Field communication (NFC) token 100 configured to transmit a license key that corresponds to one or more software features of an NFC enabled medical system 200. The method also includes positioning the NFC token 100 within an NFC activation range 504 of the NFC enabled medical system 200, and transmitting the license key to the NFC enabled medical system 200.

In one aspect, the method may include receiving identification information from the NFC enabled medical system 200. Optionally them identification information includes at least one of a user PIN, a serial number, a manufacturer dedication, or a purchase confirmation number.

In one aspect, the method may include verifying that the identification information is authorized to receive the license key.

In one aspect, the NFC token 100 may include a user input device 106, such that the transmitting operation of the method occurs once the user input device 106 is activated.

In one aspect, the NFC token 100 of the method may be enclosed within a housing.

In one aspect, the NFC activation field 500 is positioned within a reception range of an NFC reader 504 of the NFC enabled medical system 200. Optionally, the positioning operation of the method may include positioning the NFC token 100 atop of the NFC reader 504.

In one aspect, the method may include receiving the license key form a portable host system 700 of the NFC token 100. The portable host system 700 includes a transceiver configured to receive the license key from a remote location. Optionally, the portable host system may constitute as a smart phone or electronic tablet.

In one example of the inventive subject matter, a method includes receiving a feature activation request from a user interface 242. The feature activation request corresponds to one or more software features of a near field communication (NFC) enabled medical system 200. The method includes generating an NFC activation field 504, and establishing truncation with an NFC token 100 once the NFC token 100 is positioned within the NFC activation field 504. The NFC token 100 is configured to transmit a license key. The method includes transmitting identification information to the NFC token 100, and receiving the license key from the NFC token 100 corresponding to the one or more software features.

It should be noted that the various embodiments may be implemented in hardware, software or a combination thereof. The various embodiments and/or components, for example, the circuits, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid-state drive, optical disk drive, and the like. The storage device may also be other similar means for loading computer programs or other instructions into the computer or processor.

As used herein, the term “computer” or “circuit” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments. The set of instructions may be in the form of a software program. The software may be in various forms such as system software or application software and which may be embodied as a tangible and non-transitory computer readable medium. Further, the software may be in the form of a collection of separate programs or circuits, a program circuit within a larger program or a portion of a program circuit. The software also may include modular programming in the form of object-oriented programming. The processing of input data by the processing machine may be in response to operator commands, or in response to results of previous processing, or in response to a request made by another processing machine.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §612, sixth paragraph, unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal languages of the claims.

What is claimed is:

1. A near field communication (NFC) token comprising:
an antenna;
a memory device configured to store a license key, wherein the license key is used by an NFC enabled medical system to activate a software feature of the NFC enabled medical system; and
a transmitter electrically coupled to the antenna and the memory device, the transmitter configured to transmit information to the NFC enabled medical system when the transmitter is within an NFC activation field of the NFC enabled medical system, wherein the transmit information includes the license key.

2. The NFC token of claim 1, further comprising a receiver coupled to the antenna and the memory device, the receiver configured to receive information from the NFC enabled medical system.

3. The NFC token of claim 2, wherein the transmit information is transmitted in response to the receiver receiving identification information from the NFC enabled medical system, the identification information includes at least one of a user personal identification number, a serial number, a manufacturer identification, or a purchase confirmation number.

4. The NFC token of claim 1, further comprising a housing, wherein the memory device, the antenna, and the transmitter are enclosed within the housing.

5. The NFC token of claim 4, wherein the housing includes a user input device such that the transmit information is transmitted once the user input device is activated.

6. The NFC token of claim 1, further comprising a portable host system, the portable host system in communication with the memory device, the portable host system includes a transceiver configured to receive the license key from a remote location.

7. The NFC token of claim 6, wherein the portable host system constitutes a smartphone or an electronic tablet.

8. The NFC token of claim 1, wherein the NFC enabled medical system includes a user interface such that the software feature is activated by the NFC enabled medical system when identification information is received from the user interface.

9. The NFC token of claim 1, wherein the NFC activation field is positioned within a reception range of an NFC reader of the NFC enabled medical system.

10. A method for secure activation of a software feature, the method comprises:
providing a near field communication (NFC) token configured to transmit a license key that corresponds to one or more software features of an NFC enabled medical system;
positioning the NFC token within an NFC activation range of the NFC enabled medical system; and
transmitting the license key to the NFC enabled medical system.

11. The method of claim 10, further comprising receiving identification information from the NFC enabled medical system.

12. The method of claim 11, wherein the identification information includes at least one of a user personal identification number, a serial number, a manufacturer identification, or a purchase confirmation number.

13. The method of claim 10, further comprising verifying that the identification information is authorized to receive the license key.

14. The method of claim 10, wherein the NFC token includes a user input device, such that the transmitting operation occurs once the user input device is activated.

15. The method of claim 10, wherein the NFC token is enclosed within a housing.

16. The method of claim 10, wherein the NFC activation field is positioned within a reception range of an NFC reader of the NFC enabled medical system.

17. The method of claim 16, wherein the positioning operation includes positioning the NFC token atop of the NFC reader.

18. The method of claim 10, further comprising receiving the license key from a portable host system of the NFC token, wherein the portable host system includes a transceiver configured to receive the license key from a remote location.

19. The method of claim 18, wherein the portable host system constitutes a smart phone or an electronic tablet.

20. A method for secure activation of a software feature, the method comprises:
receiving a feature activation request from a user interface, wherein the feature activation request corresponds to one or more software features of a near field communication (NFC) enabled medical system;
generating an NFC activation field;
establishing communication with an NFC token once the NFC token is positioned within the NFC activation field, wherein the NFC token is configured to transmit a license key;
transmitting identification information to the NFC token; and
receiving the license key from the NFC token corresponding to the one or more software features.
